(19) United States
(12) Patent Application Publication
(10) Pub. No.: US 2013/0134094 A1
(43) Pub. Date: May 30, 2013

(54) Methods and Apparatus for Removing Impurities from Water

(71) Applicants: Bob R. Drew, Granbury, TX (US); David Potter, Granbury, TX (US); Jack Saltiel, Lawrenceville, GA (US)

(72) Inventors: Bob R. Drew, Granbury, TX (US); David Potter, Granbury, TX (US); Jack Saltiel, Lawrenceville, GA (US)

(21) Appl. No.: 13/307,195

(22) Filed: Nov. 30, 2011

(51) Int. Cl. C02F 1/44; B01D 21/01; C02F 1/52

(52) U.S. Cl. 210/652; 210/723; 210/709; 210/198.1

(57) ABSTRACT

Methods and apparatus for removing contaminants from wastewater with a high salinity content are provided. The methods include injecting a flocculant and other agents and mixing it with the wastewater. The mixture is held in a clarifying tank. The resulting clarified product is filtered through a micro filter. In the final stage, the micro filter output is passed through a series of reverse osmosis membrane. To present a stream with the appropriate salinity for the reverse osmosis filter, the micro filter output is mixed with previously cleaned water to reduce the concentration of total dissolved solids.

### BACKGROUND

1. Field of the Invention

The invention relates to methods and apparatus for removing undissolved, as well as dissolved, impurities from water. More particularly, the invention relates to methods and apparatus for recovering potable water from water contaminated during the natural gas well fracturing process.

2. General Background

Hydraulic fracturing, often called fracking, is the process of initiating and/or extending a fracture in a rock layer, employing the pressure of a fluid as the source of energy. Generally, the fracturing is done from a wellbore drilled into rock formations in order to increase the extraction rates and ultimate recovery of oil and natural gas. Hydraulic fractures may be natural or man-made and are extended by internal fluid pressure that opens the fracture and causes it to extend through the rock. Man-made fluid-driven fractures are formed by injecting fluid at high pressure to release natural gas or oil from rock formations. The fracture width is typically maintained after the injection by introducing a proppant into the injected fluid. The proppant is a material, such as grains of sand, ceramic, or other particulates, that prevents the fractures from closing when the injection is stopped.

In addition to a proppant, a wide variety of chemicals are often added to the injected fluid in order to achieve a specifically desirable viscosity. Generally, the starting fluid is lake or well water. Drillers add a specific predetermined mixture of chemicals in order to achieve the desired viscosity. A large volume of water, typically 300,000 barrels (approximately 12,600,000 gallons) is needed for fracturing each well and must be piped or trucked to the drill sites.

After the pneumatic fracturing is completed, the frac water (the fluid injected into the well) is returned to the well site by the pressure of natural gas flowing through the fracture. The returned water contains large amounts of undissolved solids, as well as sodium chlorides, barium chlorides, manganese, etc. in excess of 280,000 mgs per liter. It must be transported from the well site to a disposal site for disposal.

As more natural gas wells are drilled and put into production, there is an even greater need for access to fresh water to initiate the hydraulic fracturing process. Without an ability to clean the wastewater at a hydraulic fracturing site, natural gas producers are forced to truck large amounts of fresh water to the well sites. Thus, methods and apparatuses that allow most of these large amounts of water to be reused would reduce costs associated hydraulic fracturing by that same percentage. This is a significant savings.

The greater number of natural gas wells also leads to a higher volume of wastewater to be disposed. Not only does this wastewater have to be physically removed from the hydraulic fracturing site, but there are fees associated with the disposal of wastewater. Further, many states may restrict or prohibit entirely the use of injection wells for this purpose, causing the waste to be transported to neighboring states. These limitations not only increase the cost and risk of illegal dumping, but significantly deter the proliferation of natural gas wells and therefore, the availability of this clean energy source. Methods that reduce or eliminate the need to dispose of wastewater and reduce the quantity of fresh water required, would reduce costs, reduce illegal dumping, and allow almost five times as many wells to be drilled with the available water.

As use of the hydraulic fracturing process has increased, it has also moved closer to populated areas. This move, in particular, has led to environmental concerns about water quality. Each gas well can return to surface as much as 250,000 barrels (approximately 10,500,000 gallons) of contaminated water from the fracking process—the rest stays inside the shale—and the return water is contaminated by the chemicals used in the preparation process, as well as those absorbed during pneumatic fracturing. Thus, a process that accomplishes the cleaning of wastewater would greatly facilitate the operation and significantly improve the economics.

### BRIEF SUMMARY OF THE INVENTION

Embodiments of the invention provide a method for removing contaminants from wastewater including:

(a) moving a stream of wastewater to a first injection point;

(b) injecting a flocculent into the stream of wastewater at the first injection point;

(c) mechanically mixing the flocculent and the wastewater in an in-line mixer to create a first mixture;

(d) holding the first mixture in a first clarifier tank for a period of time to create (i) a first waste product from the particles that separate from the first mixture and settle to the bottom of the first clarifier tank; and (ii) a first clarified product;

(e) moving the first clarified product to a pressurized housing including a micro filter;

(f) filtering the first clarified product with the micro filter to create a filtered solution; and

(g) passing the filtered solution through at least one reverse osmosis membrane to produce (i) a brine waste product, and (ii) a potable water product.

Other embodiments of the invention provide that the step of passing the filtered output solution through at least one reverse osmosis membrane comprises the following steps:

(a) passing the water mixture through a reverse osmosis membrane to produce (i) a brine waste product, and (ii) a potable water product;

(b) determining the concentration of total dissolved solids in the brine waste product;

(c) adding potable water to the brine waste product in an amount sufficient to create a water mixture with a total dissolved solids concentration of approximately 25,000 ppm or less;

(d) passing the water mixture through a reverse osmosis membrane to produce (i) a brine waste product and (ii) a potable water product; and

(e) repeating steps (b)-(d) until the percentage of potable water produced from the original volume of salt-containing water is at least 75%.

Other embodiments of the invention provide that the method further includes the following steps before pumping to the pressurized housing including a micro filter:

(a) injecting an additional agent into the first clarified product at a second injection point;

(b) mechanically mixing the additional agent and the first clarified product in an in-line mixer to create a second mixture;

(c) holding the second mixture in a second clarifier tank for a period of time to create (i) a second waste product from the particles that separate from the second mixture and settle to the bottom of the second clarifier tank; and (ii) a second clarified product.

In some embodiments, the invention include the following steps before pumping to the pressurized housing including a micro filter:

(a) injecting a polymer solution into the second clarified product at a third injection point;

(b) mechanically mixing the polymer solution and the second clarified product in an in-line mixture to create a third mixture;

(c) holding the third mixture in a third clarifier tank for a period of time to create (i) a third waste product from the particles that separate from the third mixture and settle to the bottom of the third clarifier tank; and (ii) a third clarified product; and

(d) spinning the third clarified product in a continuous flow centrifuge to remove additional particulate matter and create a centrifuge output product,

wherein the centrifuge output product is pumped to the pressurized housing including a micro filter.

Embodiments of the invention also include a device for cleaning wastewater including:

(a) a holding area for holding a portion of a stream of wastewater to be cleaned;

(b) a first containing device for containing a first additive;

(c) a first injection device for injecting the first additive into the stream of wastewater;

(d) a first mixing device for mixing the first additive with the stream of wastewater and creating a first mixture;

(e) a first clarifying unit for holding the first mixture for a period of time to create (i) a first waste product from particles separating from the first mixture and settling to the bottom of the first clarifying unit; and (ii) a first clarified product;

(f) a second containing device for containing a second additive;

(g) a first mixing device for mixing the second additive with the first clarified product;

(h) a second clarifying unit for holding the second mixture for a period of time to create (i) a second waste product from particles separating from the second mixture and settling to the bottom of the second clarifying unit, and (ii) a second clarified product;

(i) a micro filter for filtering the second clarified product to create a filtered product;

(j) at least one unit for adjusting the salinity of the filtered product including a sensor for determining the conductivity of the filtered product and input from a potable water source;

(k) at least one reverse osmosis membrane for producing (i) a brine waste product, and (ii) a potable water product.

In some embodiments, the device includes at least four (4) three stage reverse osmosis membrane units.

In some embodiments, at least one unit for adjusting salinity is a single separate unit in which the salinity of the filtered product is adjusted before presentation to any of the reverse osmosis membranes.

In other embodiments, the device includes at least three (3) units for adjusting the salinity of the filtered product before each of the final three (3) three stage reverse osmosis membrane units.

Further details and embodiments of the invention are set forth below. These and other features, aspects and advantages of the invention are better understood when the following Detailed Description is read with reference to the accompanying drawings.

### BRIEF DESCRIPTION OF THE DRAWINGS

FIG. 1A-B is a diagram of a system for removing impurities from water according to embodiments of the invention.

FIG. 2 is a diagram of a system for removing impurities from water according to embodiments of the invention.

FIG. 3 is a table of data showing the percentage of potable water recovery using a system according to embodiments of the invention.

### DETAILED DESCRIPTION OF THE INVENTION

The invention generally relates to methods and apparatus for producing potable water from wastewater produced by hydraulic fracturing.

This invention will now be described more fully with reference to the drawings, showing preferred embodiments of the invention. However, this invention can be embodied in many different forms and should not be construed as limited to the embodiments set forth.

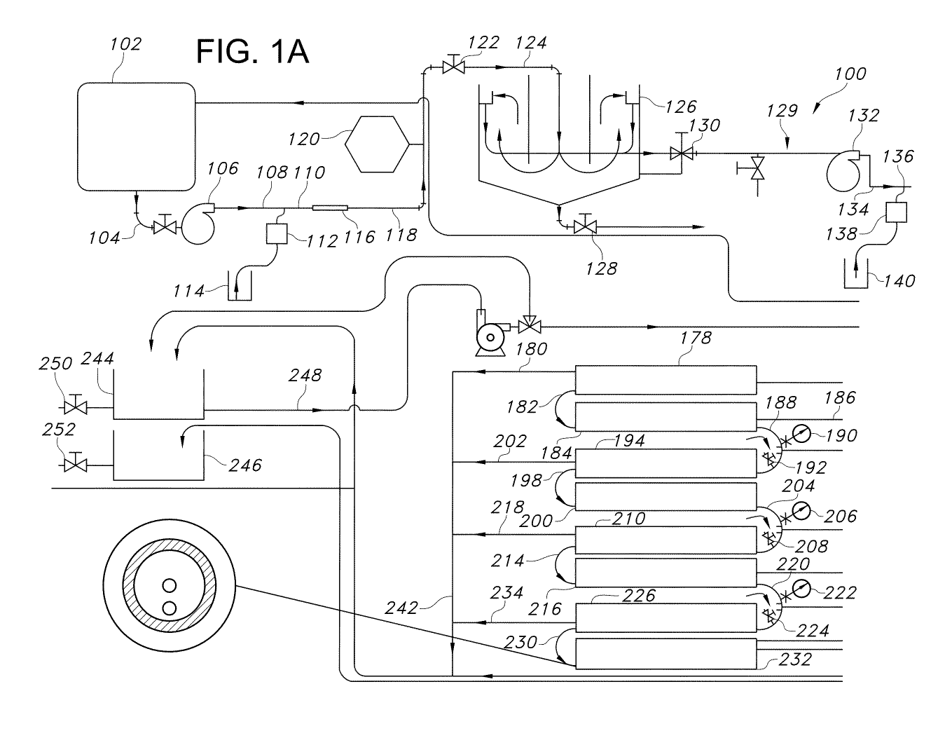

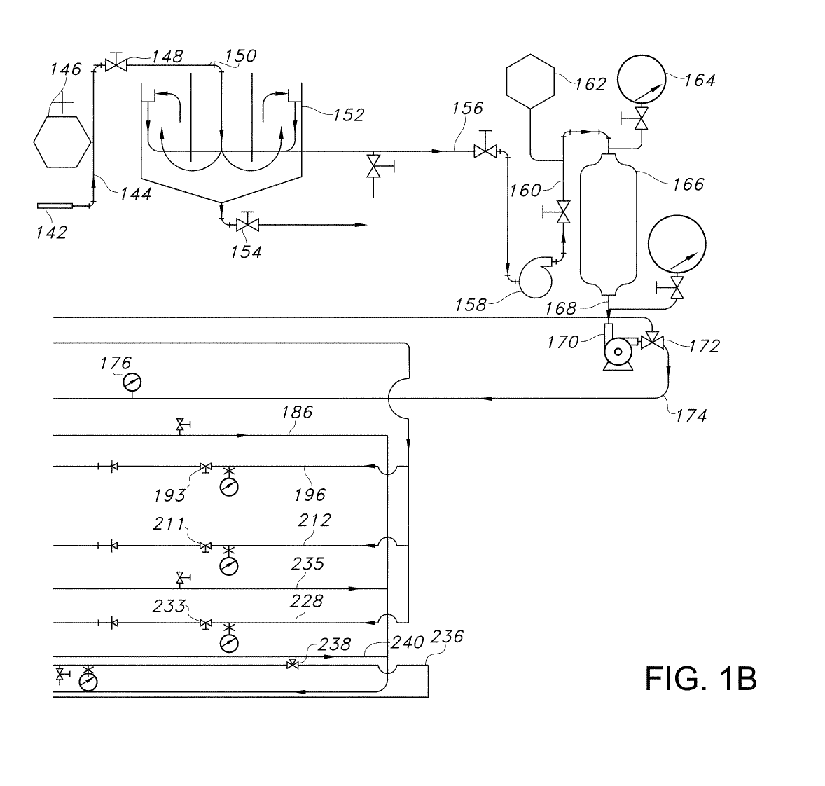

FIG. 1A-1B illustrates embodiments of the invention in which methods and systems for producing potable water from wastewater produced from hydraulic fracturing use system 100. As shown in FIG. 1A, wastewater, or “raw” water is pumped from a hydraulic fracturing site (not shown) to a wastewater storage tank 102. The wastewater may remain at the wastewater storage tank 102 for a period of time until the process of producing potable water can begin. In other embodiments of the invention, the process for producing potable water from wastewater is a continuous flow system in which the wastewater continuously flows from the hydraulic fracturing site and into the potable water production process.

In the first stage of the process of producing potable water, the wastewater is gravity-fed through pipeline 104 to low-pressure pump 106 where it is pumped through pipeline 108 to a first injection point 110. At the injection point 110, an injection device 112 is used to inject a flocculant into the stream of wastewater.

Flocculation, in the field of chemistry, is a process where colloids come out of suspension in the form of floc or flakes by the addition of a clarifying agent. The action differs from precipitation in that, prior to flocculation, colloids are merely suspended in a liquid and not actually dissolved in a solution. In the flocculated system there is no formation of a cake since all the flocs are in the suspension. In colloid chemistry, flocculation refers to the process by which fine particulates are caused to clump together into a floc. The floc may then float to the top of the liquid, settle to the bottom of the liquid, or can be readily filtered from the liquid. Flocculation and sedimentation are widely employed in the purification of drinking water as well as sewage treatment, storm water treatment and treatment of other industrial wastewater streams.

The flocculant or clarifying agent best suitable will be determined by the chemistry of the flowback water, which is the water returned after the fracking take places. For example, the appropriate flocculent used with the flowback water from the one of the test sites used, the Barnett Shale, is ferric chloride (FeCl₃) is used as the flocculant, whereas another agent may be appropriate for another gas field. This is due to the differences in the suspended colloids that may be present in the wastewater from other fields due to geological differences.

The flocculant and the wastewater are pumped to an inline mixer 116, where they are mixed to create a first mixture. From the inline mixer 116, the first mixture is pumped through pipeline 118 through the flow rate sensor 120 at which the flow rate (gallons per minute) is determined. The desired flow rate is determined by the volume requirements of the well site. It may be scaled up or down depending on the volume of wastewater being treated and the production demand for potable water by the next drill site. A flow control valve 122 in pipeline 124 can be used to adjust the flow rate as the first mixture is delivered to a first clarifier unit 126.

The first clarifier unit 126 is a holding tank for fluid that can hold at least the greatest amount of fluids that will be pumped through pipeline 124 over the period of one hour. Thus, for each 100 gallons of fluid that is pumped into the first clarifier unit 126 per minute, the first clarifier unit 126 will have a capacity of at least 6000 gallons. However, in general, the desired size of the clarifier unit 126 is determined by the needs of the hydraulic fracturing site. For example, a drill site may accommodate as few as one well, needing approximately 300,000 barrels of water, and as many as seven wells, needing over 2,000,000 barrels of water. It may be scaled up or down depending on the volume of wastewater being treated and the needed volume of potable water to be produced. The one hour rule is a minimum for the output demand, 300 gallons per minute, for example. The size of the clarifier is more likely determined by the maximum volume to be held at any one time and is not dictated by output demand, but by input demand. For example, the clarifier unit 126 may be installed as part of a sealed pond approximately one acre in size and approximately 10 feet deep. Alternatively, the clarifier unit 126 may be fiberglass tanks on portable sleds that can be transported from site to site.

The first mixture is held in first clarifier unit 126 for a period of time sufficient in duration to allow the floc produced from the first mixture to separate and settle to the bottom of the first clarifier unit 126, creating a first waste product. In particular embodiments, the first mixture is held in the first clarifier unit 126 for at least an hour allowing the floc to settle out. This first waste product exits the first clarifier unit 126 through a sludge drain, where it can be captured and disposed of appropriately or used for other purposes such as fertilizer for iron deficient soils. If the flocculant used is ferric chloride (FeCl₃), the first waste product is ferric hydroxide sludge. In other embodiments, different flocculants may result in the formation of different forms of sludge.

The settling of floc also creates a first clarified product, which exits the first clarifier unit 126 through an output pipe 129 where it flows or is pumped by low pressure pump 132 to a second clarifier unit 152. Between the first clarifier unit and the low pressure pump there is a pressure relief valve 130 which will return to the clarifier unit. In other embodiments (not shown), the first clarified product exits the first clarifier unit 126 through an overflow pipe into a sump where it is pumped into a second clarifier unit 152 with a sump or scavenge pump.

As shown in FIG. 1A, the first clarified product is pumped through pipeline 134 to a second injection point 136. At the second injection point 136, a second injection device 138 is used to inject an additional agent into the stream of the first clarified product. For example, in a representative embodiment the additional agent may be sodium hydroxide (NaOH). However, it should be understood that the additional agent used is dictated by the chemistry of the wastewater. The first clarified product and the additional agent are pumped to an inline mixer 142 in which a second mixture is created. Tank 140 holds the second clarifier agent.

The second clarifier unit 152 is similar in size to first clarifier unit 126 so that the first clarified product may be retained in the second clarifier unit 152 for at least an hour as well. As with the first clarifier unit 126, the size of the second clarifier unit 152 may be scaled up or down depending on the volume of wastewater being treated and the needed volume of potable water to be produced. The second mixture is held in the second clarifier unit 152 for a period of time to allow particles to settle and create a second waste product. This second waste product exits the second clarifier unit 152 through a sludge drain 154, where it can be captured and disposed of appropriately or packaged and sold for other purposes.

The settling of particles also creates a second clarified product, which exits the second clarifier unit 152 through output pipe 156 where it flows or is pumped by a low-pressure pump 158 to the second stage of the filtration process.

Depending on the kinds of undissolved solids in the wastewater, embodiments of the invention may include an optional third clarifier unit (not shown). In these embodiments, a polymer solution may be injected into the second clarified product at a third injection point. The polymer solution and the second clarified product may be mixed in an inline mixture to create a third mixture, which is then held in a third clarifier tank. As with the first and second clarifying units, the third mixture is held in the third clarifying unit for a period of time to allow particles to settle to the bottom of third clarifier unit and create a third waste product. This third waste product exits the third clarifier unit through a sludge drain, where it can be captured and disposed of appropriately or use for other purposes. Additional clarifying units can be added as needed and the architecture of each is similar to the first.

The settling of particles also creates a third clarified product, which exits the third clarified unit through an output pipe where it flows or is pumped by low-pressure pump to a continuous flow centrifuge where oil and other unwanted solids are extracted creating a centrifuged product. This centrifuged product then moves to the final stage of the filtration process.

In this final stage of the filtration process, the final clarified product is pumped via low pressure pump 158 to pipeline 160 to a pressurized housing 166 which includes, as a minimum, one (1) micro filter. The micro filter may be a commercially available pleated canister grouped in stages, such as the Flow-Max® Pleated Filter Cartridge, manufactured by Watts Water Technologies. The pore size of the first stage of the micro filter is approximately 50 microns, followed by 20 microns in the second stage, followed by 5 microns in the third stage. In certain embodiments the pore size of the first stage of the micro filter is 20 microns followed by 5 microns and the pore size of the second stage is 1 micron followed by 0.35 micron. The operating pressure of the micro filter is 30+/−5 psi.

As shown in FIG. 1B, the final output of the micro filter (micro filter product) exits the pressurized housing 166 via pipeline 168. The micro filter product is pumped via high-pressure pump 170 through a high-pressure feed pipe 174. A relief valve 172 at high-pressure pump 170 diverts a portion of the micro filter product as necessary to achieve the desired pressure. After the micro filter product exits the high-pressure feed pipe 174, it passes through a series of reverse osmosis (“RO”) membranes (178, 184, 194, 200, 210, 216, 226, 232).

The Reverse Osmosis membranes work on the principle that water (H₂O) molecules are among the smallest of molecular structures. In a reverse osmosis process as herein described, the water, which is now cleaned of all suspended particles but is still contaminated with a variety of molecules that remain in solution, is prevented from continuing downstream until the reserve osmotic pressure is overcome. Once the osmotic pressure is overcome, then H₂O molecules reform on the downstream side of the membrane leaving behind all smaller molecules and the remainder of H₂O molecules, thus separating the original stream of water into two streams, potable and reject water.

At each of the reverse osmosis membranes, fractional amounts of previously cleaned water are mixed with the micro filter output to achieve optimum salt content prior to presentation to the reverse osmosis membranes

As the micro filter product moves through high-pressure feed pipe 174, the pressure is checked by pressure gauge 176. The micro filter product moves though a first portion of first pass RO membrane 178 then through pipeline 186 to a second portion of first pass RO membrane 184. A portion of the micro filter product exits the first pass RO membrane 178 through pipeline as potable water. This portion is pumped or gravity fed through pipeline 242 to a potable water tank 244 Potable water tank 244 includes an output pipe 248 leading back to the RO membranes, so that potable water can be added to the flow as needed to adjust the concentration of total dissolved solids.

The remaining portion of the fluid passed through the first pass RO membrane exits first pass RO membrane 184 as first pass RO membrane product. The first pass RO membrane product exits through pipeline 188, which includes pressure gauge 190 to check the pressure and total dissolved solids (“TDS”) sample point 192 to check the total dissolved solids. If the concentration of total dissolved solids is found to be too high, indicating that the concentration of salts is too high for presentation to the second pass RO membrane 194, additional potable water is added via the flow control 193 in pipeline 196. Potable water is added to achieve the desired concentration of TDS. Generally, a TDS of about 25,000 ppm is acceptable for presentation at the RO membranes.

The first pass RO membrane product moves through the first portion of second pass RO membrane 194. A portion of the first pass RO membrane product exits the first portion of second pass RO membrane 194 through pipeline 202 as potable water. This portion is pumped or gravity fed through pipeline 242 to the potable water tank 244.

Another portion of the first pass RO membrane product is a brine waste product that continues through to the second portion of second pass RO membrane 200 through pipeline 198 and emerges as second pass RO membrane product. The second pass RO membrane product exits through pipeline 204, which includes pressure gauge 206 to check the pressure and TDS sample point 208 to check the concentration of total dissolved solids. If the concentration of total dissolved solids is found to be too high, indicating that the concentration of salts is too high for presentation to the third pass RO membrane, additional potable water is added via the flow control 211 in pipeline 212.

The second pass RO membrane product moves through first portion of the third pass RO membrane 210. A portion of the second pass RO membrane product exits the first portion of third pass RO membrane 210 through pipeline 218 as potable water. This portion is pumped or gravity fed through pipeline 242 to the potable water tank 244. Another portion of the second pass RO membrane product is a brine waste product that continues through to the second portion of third pass RO membrane 216 through pipeline 214 and emerges as third pass RO membrane product.

A portion of the third pass RO membrane product exits through pipeline 235 and is pumped or gravity fed through to the potable water tank 244.

Another portion of the third pass RO membrane product exits through pipeline 220, which includes pressure gauge 222 to check the pressure and TDS sample point 224 to check the total dissolved solids. If the concentration of total dissolved solids is found to be too high, indicating that the concentration of salts is too high for presentation to the first portion of forth pass RO membrane 226, additional potable water is added via the flow control 233 in pipeline.

The third pass RO membrane product moves through the first portion of fourth pass RO membrane 226. A portion of the third pass RO membrane product exits the first portion of fourth pass RO membrane 226 through pipeline 234 as potable water. This portion is pumped or gravity fed through pipeline 242 to the potable water tank 244.

Another portion of the third pass RO membrane product is a brine waste product that continues through to the second portion of fourth pass RO membrane 232 through pipeline 230 and emerges as fourth pass RO membrane product. The fourth pass RO membrane product exits through pipeline 240 and is pumped or gravity fed to the potable water tank 244. A back-pressure regulator 238 along pipeline 239 adjusts the pressure of the flow so that a pressure of less than 1000 psi is achieved. The back pressure regulator 238 is a relief valve to prevent membrane rupture. If the pressure exceeds 1000 psi, the back pressure regulator relieves the pressure and sends it back to the brine water tank 246.

Test results have shown that seven (7) stages will achieve the maximum recovery ratio; however, four (4) stages satisfy most recovery targets. By presenting input water at the optimal mix, the selected membranes will produce potable water at rates in excess of 75% of input volume from brackish water containing up to 40,000 ppm of salts. As those with skill in the art will appreciate, differing numbers of stages may be used to achieve the desired amount of potable water.

### Example 1

Wastewater from hydraulic fracturing in Barnett Shale in Texas was treated according to embodiments of the invention. Ferric chloride (FeCl₃) was injected into the stream of wastewater and the two were mixed in an inline mixer. The mixture was held in a sealed pond approximately 1 acre in size and 10 feet deep, where it was clarified and particles settled out. The clarified mixture was then injected with sodium hydroxide and the two were mixed in an inline mixer to create a second mixture. This mixture was then held in another seal pond approximately 1 acre in size and 10 feet deep, where it was clarified and particles settled out.

The second clarified mixture was then filtered by a Flow-Max® Pleated Filter Cartridge, manufactured by Watts Water Technologies, with a pore size of approximately 20 microns followed by 5 microns in the first stage and a pore size of 1 micron followed by 0.35 micron in the second stage. The operating pressure of the micro filter was approximately 30 psi.

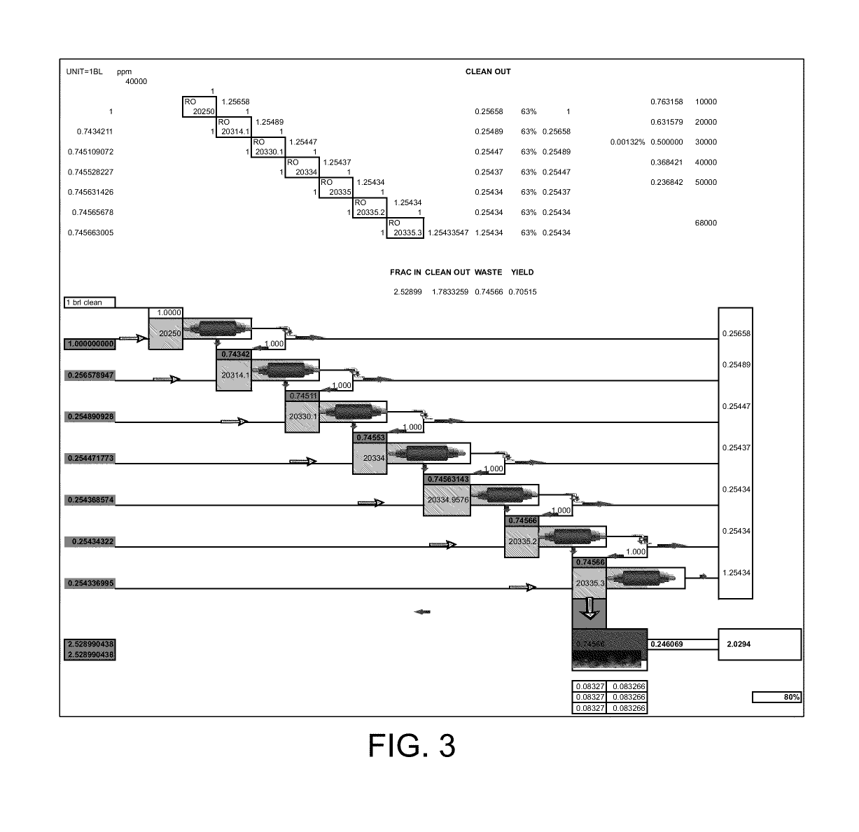

The salinity of the filtered product was determined by measuring the concentration of total dissolved solids. The salinity was adjusted in a salinity adjustment tank by adding potable water until the concentration of total dissolved solids was approximately 25,000 ppm. The adjusted filtered product was then passed through a series of seven (7) reverse osmosis membranes. As shown in FIG. 3, potable water was recovered at a rate of approximately 80% of the input volume.

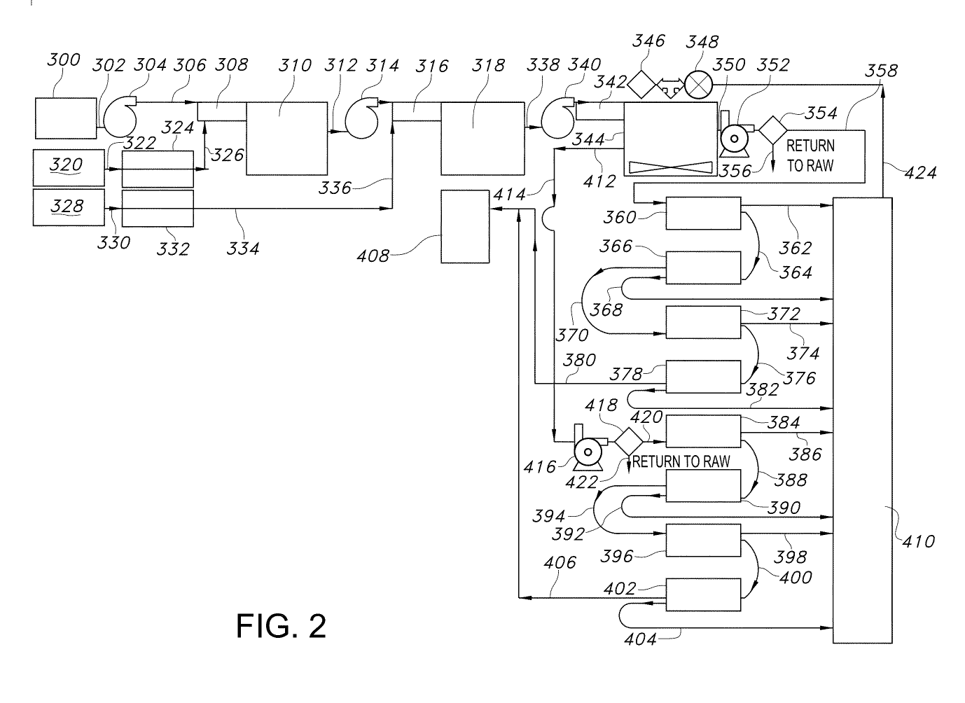

As shown in FIG. 2, other embodiments of the invention may include adjustment of the concentration of total dissolved solids at one point before presentation to the RO membranes, instead of adjustment at each RO membrane. As shown in FIG. 2, wastewater is pumped from the hydraulic fracturing site (not shown) to a wastewater storage tank 300. The wastewater may remain at the wastewater storage tank 300 for a period of time until the process of producing potable water can begin. In other embodiments of the invention, the process for producing potable water from wastewater is a continuous flow system in which the wastewater continuously flows from the hydraulic fracturing site and into the potable water production process.

In the first stage of the process, the wastewater is gravity-fed through pipeline 302 to low-pressure pump 304, where it is pumped through pipeline 306 to an inline mixer 308. At the inline mixer 308, the wastewater is mixed with a flocculant that is dictated by the chemistry of the wastewater to create a first mixture.

The flocculant is held in a tank 320 where it is pumped via pipeline 322 to injection pump 324. Injection pump 324 pumps the flocculant via pipeline 326 to the inline mixer 308.

The first mixture flows to a first clarifier unit 310, where it is held for a period of time so that particles from the first mixture separate and settle to the bottom of the first clarifier unit 310, creating a first waste product and a first clarified product. The first clarified product continues through pipeline 312 to low-pressure pump 314, where it is pumped to a second inline mixer 316. At the second inline mixer, the first clarified product is mixed with an additional agent that is dictated by the chemistry of the wastewater to create a second mixture.

The additional agent is held in a second tank 328 where it is pumped via pipeline 330 to second injection pump 332. Injection pump 332 pumps the additional agent via pipelines 334, 336 to the second inline mixer 316.

The second mixture continues to a second clarifier unit 318, where it is held for a period of time so that particles from the second mixture separate and settle to the bottom of the second clarifier unit 318, creating a second waste product and a second clarified product. The second clarified product continues through pipeline 338 to low-pressure pump 340, which pumps the second clarified product to the second stage of the impurity removal process.

In the second stage of the impurity removal process, the second clarified product is pumped to a pressurized housing including a micro filter 342. Filtration in the pressurized housing 342 creates a micro filter product. The micro filter product moves to a salinity adjustment tank 344. In the salinity adjustment tank 344, a conductivity sensor 346 measures the concentration of total dissolved solids. Potable water from a potable water tank 410 is pumped through a filter 348 and added to the micro filter product in salinity adjustment tank 344. The addition of potable water reduces the concentration of total dissolved solids until the desired concentration is achieved and an adjusted micro filter product is created.

The adjusted micro filter product is pumped via high pressure pump 352 to pipeline 358. Pipeline 358 includes a relief valve 354 that prevents rupture of the reverse osmosis (“RO”) membranes. If the pressure exceeds 1000 psi, the relief valve 354 releases a portion of the adjusted micro filter product through pipeline 356, where it is returned to the wastewater tank 300.

The adjusted micro filter product is pumped via pipeline 358 to first RO membrane 360. A portion of adjusted micro filter product exits the first RO membrane 360 as potable water via pipeline 362 to potable water tank 410. The remaining portion is a brine waste product that exits first RO membrane 360 as a first membrane product through pipeline 364.

First membrane product moves through pipeline 364 to second RO membrane 366. A portion of first membrane product exits the second RO membrane 366 as potable water via pipeline 368 to potable water tank 410. The remaining portion is a brine waste product that exits second RO membrane 366 as a second membrane product through pipeline 370.

Second membrane product moves through pipeline 370 to third RO membrane 372. A portion of second membrane product exits the third RO membrane 372 as potable water via pipeline 374 to potable water tank 410. The remaining portion is a brine waste product that exits third RO membrane 372 as a third membrane product through pipeline 376.

Third membrane product moves through pipeline 376 to fourth RO membrane 378. A portion of third membrane product exits the fourth RO membrane 378 as potable water via pipeline 382 to potable water tank 410. The remaining portion is a brine waste product that exits fourth RO membrane 378 via pipeline 380 to brine water tank 408.

Another portion of adjusted micro filter product exits salinity adjust tank 344 via pipelines 412, 414. It is then pumped via high pressure pump 416 to pipeline 420. Pipeline 420 includes a relief valve 418 that prevents rupture of the RO membranes. If the pressure exceeds 1000 psi, the relief valve 418 releases a portion of the adjusted micro filter product through pipeline 422, where it is returned to the wastewater tank 300.

The adjusted micro filter product is pumped via pipeline 420 to fifth RO membrane 384. A portion of adjusted micro filter product exits the fifth RO membrane 384 as potable water via pipeline 386 to potable water tank 410. The remaining portion is a brine waste product that exits fifth RO membrane 384 as a fifth membrane product through pipeline 388.

Fifth membrane product moves through pipeline 388 to sixth RO membrane 390. A portion of fifth membrane product exits the sixth RO membrane 390 as potable water via pipeline 392 to potable water tank 410. The remaining portion is a brine waste product that exits sixth RO membrane 390 as a seventh membrane product through pipeline 394.

Sixth membrane product moves through pipeline 394 to seventh RO membrane 396. A portion of sixth membrane product exits the seventh RO membrane 396 as potable water via pipeline 398 to potable water tank 410. The remaining portion is a brine waste product that exits seventh RO membrane 396 as seventh membrane product through pipeline 400.

Seventh membrane product moves through pipeline 400 to eighth RO membrane 402. A portion of seventh membrane product exits the eighth RO membrane 402 as potable water via pipeline 404 to potable water tank 410. The remaining portion is a brine waste product that exits eighth RO membrane 402 via pipeline 406 to brine water tank 408.

It should be understood that all of the steps in this process may be automated. For example, the addition of potable water to the stream to adjust the conductivity may be automated by the inclusion of automatic flow control valves, whereby all motors are automatically started, their speeds controlled, pressures adjusted, quantities of liquids injected, etc. under computer control and displayed on one or more touch screen monitors at multiple locations. The volumes of both raw water and potable water received and sold are computer monitored and recorded for billing and audit purposes.

In order to operate the system it is only necessary to boot up the control computer and follow simple instructions on the screen, such as:
TO BEGIN OPERATION PRESS HERE
TO CEASE OPERATION PRESS HERE
TO OBSERVE FLOW RATE AT ANY POINT PRESS THE DIAGRAM AT THE DESIRED PROCESS POINT.

The foregoing description is provided for describing various embodiments and structures relating to the invention. Various modifications, additions and deletions may be made to these embodiments and/or structures without departing from the scope and spirit of the invention.

1. A method for removing contaminants from wastewater comprising:
(a) moving a stream of wastewater to a first injection point;
(b) injecting a flocculant into the stream of wastewater at the first injection point;
(c) mechanically mixing the flocculant and the wastewater in an in-line mixer to create a first mixture;
(d) holding the first mixture in a first clarifier tank for a period of time to create (i) a first waste product from the particles that separate from the first mixture and settle to the bottom of the first clarifier tank; and (ii) a first clarified product;
(e) moving the first clarified product to a pressurized housing including a micro filter;
(f) filtering the first clarified product with the micro filter to create a filtered solution; and
(g) passing the filtered solution through at least one reverse osmosis membrane to produce (i) a brine waste product and (ii) a potable water product.

2. The method of claim 1, wherein the step of passing the filtered output solution through at least one reverse osmosis membrane comprises the following steps:
(a) passing the water mixture through a reverse osmosis membrane to produce (i) a brine waste product and (ii) a potable water product;
(b) determining the concentration of total dissolved solids in the brine waste product;
(c) adding potable water to the brine waste product in an amount sufficient to create a water mixture with a total dissolved solids concentration of approximately 25,000 ppm or less;
(d) passing the water mixture through a reverse osmosis membrane to produce (i) a brine waste product and (ii) a potable water product; and
(e) repeating steps (b)-(d) until the percentage of potable water produced from the original volume of salt-containing water is at least 65%.

3. The method of claim 1, wherein the flocculent is ferric chloride (FeCl₃).

4. The method of claim 1, further comprising the following steps before pumping to the pressurized housing including a micro filter:
(a) injecting an additional agent into the first clarified product at a second injection point;
(b) mechanically mixing the additional agent and the first clarified product in an in-line mixer to create a second mixture;
(c) holding the second mixture in a second clarifier tank for a period of time to create (i) a second waste product from the particles that separate from the second mixture and settle to the bottom of the second clarifier tank; and (ii) a second clarified product.

5. The method of claim 1, further comprising the following steps before pumping to the pressurized housing including a micro filter:
(a) injecting a polymer solution into the first clarified product at a second injection point;
(b) mechanically mixing the polymer solution and the first clarified product in an in-line mixture to create a second mixture;
(c) holding the second mixture in a second clarifier tank for a period of time to create (i) a second waste product from the particles that separate from the second mixture and settle to the bottom of the second clarifier tank; and (ii) a second clarified product; and
(d) spinning the second clarified product in a continuous flow centrifuge to remove additional particulate matter and create a centrifuge output product,
wherein the centrifuge output product is pumped to the pressurized housing including a micro filter.

6. The method of claim 4, further comprising the following steps before pumping to the pressurized housing including a micro filter:
(a) injecting a polymer solution into the second clarified product at a third injection point;
(b) mechanically mixing the polymer solution and the second clarified product in an in-line mixture to create a third mixture;
(c) holding the third mixture in a third clarifier tank for a period of time to create (i) a third waste product from the particles that separate from the third mixture and settle to the bottom of the third clarifier tank; and (ii) a third clarified product; and
(d) spinning the third clarified product in a continuous flow centrifuge to remove additional particulate matter and create a centrifuge output product,
wherein the centrifuge output product is pumped to the pressurized housing including a micro filter.

7. The method of claim 4, wherein the additional agent is sodium hydroxide (NaOH).

8. The method of claim 1, wherein the first mixture is held in the first clarifier tank for at least one hour.

9. The method of claim 5, wherein the second mixture is held in the second clarifier tank for at least one hour.

10. The method of claim 1, further comprising a control panel for automating the method.

11. The method of claim 1, wherein the wastewater is wastewater created by hydraulic fracturing.

12. A method for increasing the amount of potable water produced from water containing dissolved salts comprising:
(a) Passing a volume of salt-containing water through a micro filter to create a filtered output solution;
(b) Passing the water mixture through a reverse osmosis membrane to produce (i) a brine waste product and (ii) a potable water product,
(c) Determining the total dissolved solids concentration of the brine waste product;
(d) Adding potable water to the brine waste product in an amount sufficient to create a water mixture with a total dissolved solids concentration of 25,000 ppm or less;
(e) Passing the water mixture through a reverse osmosis membrane to produce (i) a brine waste product and (ii) a potable water product; and
(f) Repeating steps (c)-(e) until the percentage of potable water produced from the original volume of salt-containing water is at least 65%.

13. The method of claim 12, wherein the water mixture is passed through a reverse osmosis membrane at least four (4) times.

14. The method of claim 12, wherein the micro filter is a pleated canister grouped in stages.

15. The method of claim 14, wherein the micro filter is a pleated canister grouped in two stages, wherein the pore size of the first stage is approximately 20 microns, followed by 5 microns and the pore size of the second stage is approximately 1 micron, followed by 0.35 micron.)

16. A reverse osmosis method for increasing the amount of potable water produced from a volume of water containing dissolved salts comprising:
(a) moving a stream of wastewater to a first injection point;
(b) injecting a flocculant into the stream of wastewater at the first injection point;
(c) mechanically mixing the flocculant and the wastewater in an in-line mixer to create a first mixture;
(d) holding the first mixture in a first clarifier tank for a period of time to create (i) a first waste product from the particles that separate from the first mixture and settle to the bottom of the first clarifier tank; and (ii) a first clarified product;
(e) injecting an additional agent into the first clarified product at a second injection point;
(f) mechanically mixing the additional agent and the first clarified product in an in-line mixer to create a second mixture;
(g) holding the second mixture in a second clarifier tank for a period of time to create (i) a second waste product from the particles that separate from the second mixture; and (ii) a second clarified product;
(h) filtering the second product with the micro filter to create a filtered output solution; and
(i) passing the filtered output solution through a reverse osmosis membrane to produce (i) a brine waste product and (ii) a potable water product,
(j) determining the total dissolved solids concentration of the brine waste product;
(k) adding potable water to the brine waste product in an amount sufficient to create a water mixture with a total dissolved solids concentration of 25,000 ppm or less;
(l) passing the water mixture through a reverse osmosis membrane to produce (i) a brine waste product and (ii) a potable water product; and
(m) Repeating steps (j)-(l) until the percentage of potable water produced from the original volume of salt-containing water is at least 65%.)

17. The method of claim 16, wherein the flocculant is ferric chloride (FeCl₃).

18. The method of claim 16, wherein the additional agent is sodium hydroxide (NaOH).

19. The method of claim 16, wherein the first mixture is held in the first clarifier tank for at least one hour.

20. The method of claim 16, wherein the second mixture is held in the second clarifier tank for at least one hour.

21. The method of claim 16, wherein the wastewater is wastewater created by hydraulic fracturing.

22. The method of claim 16, wherein the water mixture is passed through a reverse osmosis membrane at least four (4) times.

23. The method of claim 16, wherein the micro filter is a pleated canister grouped in stages.

24. The method of claim 23, wherein the micro filter is a pleated canister grouped in two stages, wherein the pore size of the first stage is approximately 20 microns, followed by 5 microns and the pore size of the second stage is approximately 1 micron, followed by 0.35 micron.

25. A device for cleaning wastewater comprising:
(a) a holding area for holding a portion of a stream of wastewater to be cleaned;
(b) a first containing device for containing a first additive;
(c) a first injection device for injecting the first additive into the stream of wastewater;
(d) a first mixing device for mixing the first additive with the stream of wastewater and creating a first mixture;
(e) a first clarifying unit for holding the first mixture for a period of time to create (i) a first waste product from particles separating from the first mixture and settling to the bottom of the first clarifying unit; and (ii) a first clarified product;
(f) a second containing device for containing a second additive;
(g) a first mixing device for mixing the second additive with the first clarified product;
(h) a second clarifying unit for holding the second mixture for a period of time to create (i) a second waste product from particles separating from the second mixture and settling to the bottom of the second clarifying unit, and (ii) a second clarified product;
(i) a micro filter for filtering the second clarified product to create a filtered product;
(j) at least one unit for adjusting the salinity of the filtered product including a sensor for determining the conductivity of the filtered product and input from a potable water source;
(k) at least one reverse osmosis membrane for producing (i) a brine waste product, and (ii) a potable water product.

26. The device of claim 25, wherein the device includes at least four (4) reverse osmosis membranes.

27. The device of claim 25, wherein the at least one unit for adjusting salinity is a single separate unit in which the salinity of the filtered product is adjusted before presentation to any of the reverse osmosis membranes.

28. The device of claim 25, wherein device includes at least three (3) units for adjusting the salinity of the filtered product before each of the final three (3) reverse osmosis membranes.

29. The device of claim 25, wherein the first additive is a flocculant.
